(19) United States
(12) Patent Application Publication
(10) Pub. No.: US 2018/0186119 A1
(43) Pub. Date: Jul. 5, 2018

(54) DISPLAY PANEL AND DISPLAY DEVICE

(71) Applicant: BOE TECHNOLOGY GROUP CO., LTD., Beijing (CN)

(72) Inventors: Jing YANG, Beijing (CN); Peng CAI, Beijing (CN)

(21) Appl. No.: 15/563,578

(22) PCT Filed: Apr. 17, 2017
(86) PCT No.: PCT/CN2017/080750

§ 371 Date: Sep. 30, 2017

(30) Foreign Application Priority Data
May 13, 2016 (CN) 201610320041.8

(51) Int. Cl. B32B 7/04; H01F 10/16; H01F 10/12; B32B 15/04

(52) U.S. Cl. CPC B32B 7/04; H01F 10/16; B32B 2457/208; B32B 15/04; H01F 10/126

(57) ABSTRACT

A display panel and a display device is disclosed. The display panel includes a stack structure including a plurality of functional film layers stacked successively; and two film layers which are disposed on an upper surface and a lower surface of the stack structure, respectively and attractable to each other by a magnetic force.

### RELATED APPLICATION

The present application is the U.S. national phase entry of PCT/CN2017/080750, with an international filing date of Apr. 17, 2017, which claims the benefit of Chinese Patent Application No. 201610320041.8, filed on May 13, 2016, the entire disclosure of which is incorporated herein by reference.

### FIELD

The present disclosure relates to the display panel field, and particularly to a display panel and a display device.

### BACKGROUND

With the development of the display manufacturing technology, original cathode ray tube (CRT) displays are replaced by light emitting diode (LED) displays. However, when the LED has become dominant in the market, people are not satisfied and still pursuing a light, thin design of the display. The popularization of an ultra-thin display is bound to be a new trend of the development of the display. In addition to moving an adapter to the outside, a display which employs a lighter and thinner display panel would necessarily become the user's first choice. At present, for the existing display panel, the existing production process usually utilizes attached polarizer and touch screen. According to the existing attachment manner, the optical adhesive has a thickness of up to 275 μm, resulting in a thick display panel. In order to realize a light, thin design of the display, it is necessary to further reduce the thickness of the display panel.

In summary, in the prior art display panel, an optical adhesive is used to attach a plurality of functional film layers such as a polarizer and a touch screen. Due to the large thickness of the applied optical adhesive, the display panel is relatively thick.

### SUMMARY

Embodiments of the present disclosure provide a display panel and a display device for solving the problem that in the prior art display panel, an optical adhesive is used to attach a plurality of functional film layers such as a polarizer and a touch screen, which results in a thick display panel due to the large thickness of the applied optical adhesive.

Embodiments of the present disclosure provide a display panel comprising: a stack structure comprising a plurality of functional film layers stacked successively; and two film layers which are disposed on an upper surface and a lower surface of the stack structure, respectively and attractable to each other by a magnetic force.

In certain exemplary embodiments, the two film layers are a nano metal film layer or a first magnetic film layer disposed on the upper surface of the stack structure, and a second magnetic film disposed on the lower surface of the stack structure.

In certain exemplary embodiments, materials of the first magnetic film layer and the second magnetic film layer are a mixture of a magnetic material and a sizing having a viscosity value smaller than a preset threshold, wherein the preset threshold is a minimum viscosity value that affects the normal operation of the display panel.

In certain exemplary embodiments, the magnetic material is one or a combination of any of the following materials: nano iron chrome cobalt, nano aluminum nickel cobalt, nano samarium cobalt and nano rubidium iron boron.

In certain exemplary embodiments, a mass ratio of the magnetic material in the mixture is from 0.03% to 0.17%.

In certain exemplary embodiments, the sizing is a quick-drying paint.

In certain exemplary embodiments, the upper surface of the stack structure is a display surface, and the nano metal film layer or the first magnetic film layer is disposed in a non-display area of the display panel.

In certain exemplary embodiments, the thickness of the nano metal film layer or the first magnetic film layer is 5 μm.

In certain exemplary embodiments, the lower surface of the stack structure is a non-display surface, and the second magnetic film layer is an entire layer or is disposed in a non-display area of the display panel.

In certain exemplary embodiments, the thickness of the second magnetic film layer is not more than 5 μm.

In certain exemplary embodiments, the display panel is a flexible display panel.

Embodiments of the present disclosure provide a display device comprising the above display panel provided by embodiments of the present disclosure.

Advantageous effects of embodiments of the present disclosure are as follows: in embodiments of the present disclosure, the upper surface and the lower surface of the stack structure are respectively provided with two film layers which can be attracted to each other by a magnetic force, and individual film layers of the display panel are fixed by a magnetic force, so that the optical adhesive in the existing display panel is replaced, thereby reducing the thickness of the display panel and further realizing an ultra-thin design of the display panel.

### BRIEF DESCRIPTION OF DRAWINGS

FIG. 1 is a schematic structural view of a display panel provided by embodiments of the present disclosure;

FIG. 2 is a top view of the display panel of FIG. 1 as provided by embodiments of the present disclosure.

### DETAILED DESCRIPTION

Technical solutions in embodiments of the present disclosure will be described below in a clear and complete manner with reference to the accompanying drawings in the embodiments of the present disclosure. Apparently, the described embodiments are merely part of the embodiments of the present disclosure, rather than all of them. All other embodiments obtained by those ordinarily skilled in the art based on the embodiments of the present disclosure without spending inventive efforts are within the scope of the present disclosure.

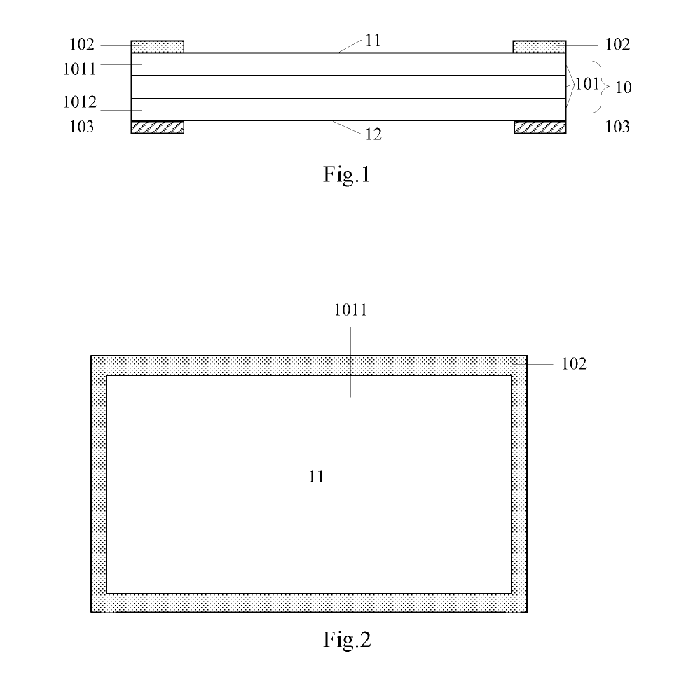

As shown in FIG. 1 which is a schematic structural view of a display panel provided by embodiments of the present disclosure, the display panel comprises: a stack structure 10 comprising a plurality of functional film layers 101 stacked successively, and two film layers 102, 103 which are disposed on an upper surface 11 and a lower surface 12 of the stack structure 10, respectively and attractable to each other by a magnetic force.

In a prior art display panel, an optical adhesive is used to attach a plurality of functional film layers such as a polarizer and a touch screen. Since the applied optical adhesive has a large thickness that is even up to 275 μm, the display panel is thick. In embodiments of the present disclosure, the upper surface 11 and the lower surface 12 of the stack structure 10 (i.e. the upper surface of a layer 1011 and the lower surface of a layer 1012 in FIG. 1) are respectively provided with two film layers 102, 103 which can be attracted to each other by a magnetic force, and the plurality of functional film layers 101 of the display panel are fixed by a magnetic force, so that the optical adhesive in the prior art display panel is replaced, thereby reducing the thickness of the display panel and further realizing an ultra-thin design of the display panel.

Upon implementation, the display panel according to embodiments of the present disclosure may be a conventional display panel or a flexible display panel formed on the basis of a flexible base material, as long as a plurality of functional film layers can be fixed by a magnetic force between two film layers. In certain exemplary embodiments, the display panel is a flexible display panel. In embodiments of the present disclosure, the plurality of functional film layers 101 of the display panel are fixed by a magnetic force, thereby reducing the thickness of the display panel, further reducing a longitudinal stress of the flexible display panel during bending, decreasing a bending radius, preventing the display quality from being affected by a fracture of electrodes in the flexible display panel under the effect of stress, and improving the stability of the electrical performance of thin film transistors (TFT).

The above two film layers which can be attracted to each other by a magnetic force may be two magnetic films having opposite polarities. Alternatively, one of the above two film layers which can be attracted to each other by a magnetic force may a magnetic film layer, and the other is a nano metal film layer. In certain exemplary embodiments, the two film layers are a nano metal film layer or a first magnetic film layer 102 disposed on the upper surface 11 of the stack structure 10, and a second magnetic film layer 103 disposed on the lower surface 12 of the stack structure 10, respectively. Moreover, in the context of the present disclosure, although the two layers are referred to as “film layers”, either may, for example, be a film layer in a form of a frame or include several strip film layer elements arranged on a same surface, rather than a film layer that entirely covers, for example, the upper surface of the stack structure.

Upon implementation, the materials of the two film layers may not be defined, as long as they can be attracted to each other by a magnetic force. For example, magnetic materials having opposite polarities may be attracted to each other, and a magnetic material and a metal may also be attracted to each other.

In the case where the two film layers are magnetic film layers, the materials of the first magnetic film layer 102 and the second magnetic film layer 103 are in certain exemplary embodiments a mixture of a magnetic material and a sizing having a viscosity value smaller than a preset threshold, wherein the preset threshold is a minimum viscosity value that affects the normal operation of the display panel. In certain exemplary embodiments, the sizing is a quick-drying paint.

Upon implementation, the first magnetic film layer and the second magnetic film layer are both a mixture of a magnetic material and a less viscous sizing. During implementation, the viscosity of the magnetic film layer at least cannot affect the normal operation of the display panel. When manufacturing the first magnetic film layer and the second magnetic film layer, a quick-drying paint having small viscosity can be used. The magnetic material is added to a quick-drying paint at a certain mass ratio, which are stirred uniformly using a magnetic stirrer and coated in the form of a thin film, thereby obtaining the first magnetic film layer 102 and the second magnetic film layer 103 provided by embodiments of the present disclosure. The first magnetic film layer and the second magnetic film layer are just to distinguish them and do not have special meanings, both of which are magnetic thin film layers.

Upon implementation, the magnetic material and the sizing are mixed at a certain mass ratio, and in certain exemplary embodiments, the mass ratio of the magnetic material in the mixture is 0.03% to 0.17%. The proportion of the magnetic material in the mixture cannot be too high or too low. Too much magnetic material may cause the sizing to be unable to well adhere to the magnetic material, so that a thin film cannot be formed. Too little magnetic material may be unable to well fix the plurality of functional film layers 101 due to insufficient magnetic force.

Regarding the magnetic material described above, materials which can be made into nano-scale magnetic materials are all applicable to the embodiments of the present disclosure. In certain exemplary embodiments, the magnetic material is one or a combination of any of the following materials: nano iron chrome cobalt, nano aluminum nickel cobalt, nano samarium cobalt and nano rubidium iron boron. In certain exemplary embodiments, the nano metal is nickel. Upon implementation, both the magnetic material and the nano metal may be selected as other materials as necessary, as long as they are nano-scale materials that can be made into thin films and enable the resulting two film layers to be attracted to each other by a magnetic force so as to fix a plurality of functional film layers.

Parameters such as position and thickness of the nano metal film layer or the first magnetic film layer 102 and the second magnetic film layer 103 according to embodiments of the present disclosure will be described below in detail.

Regarding the nano metal film layer or the first magnetic film layer 102:

as shown in FIG. 2 which is a top view of the display panel of FIG. 1 as provided by embodiments of the present disclosure, upon implementation, the nano metal film layer or the first magnetic film layer 102 should be disposed in a non-display area in order not to affect the display effect of the display panel. In certain exemplary embodiments, the upper surface 11 of the stack structure 10 is a display surface, and the nano metal film layer or the first magnetic film layer 102 is disposed in a non-display area of the display panel.

Upon implementation, the thickness of the nano metal film layer or the first magnetic film layer 102 may be set as necessary. In certain exemplary embodiments, the thickness of the nano metal film layer or the first magnetic film layer 102 is 5 μm. During implementation, other sizes may be selected as necessary, but it is necessary to ensure that the magnetic force for attracting the nano metal film layer or the first magnetic film layer 102 to the second magnetic film layer 103 is able to fix the plurality of functional film layers.

Regarding the second magnetic film layer 103:

A position and width of the second magnetic film layer 103 may be set as necessary if the display panel provided by embodiments of the present disclosure is a single-sided display panel and the lower surface 12 of the stack structure 10 is a non-display surface. In certain exemplary embodiments, the lower surface 12 of the stack structure 10 is a non-display surface, and the second magnetic film layer 103 is an entire layer or is disposed in a non-display area of the display panel. Since the second magnetic film layer 103 is disposed outside the plurality of functional film layers of the display panel and on a non-display surface, even if the second magnetic film layer 103 is set as an entire layer, it will not affect the normal operation of the display panel, either.

Upon implementation, the thickness of the second magnetic film layer 103 may be set as necessary. In certain exemplary embodiments, the thickness of the second magnetic film layer 103 is not more than 5 μm. During implementation, other sizes may be selected as necessary, but it is necessary to ensure that the magnetic force for attracting the second magnetic film layer 103 to the nano metal film layer or the first magnetic film layer 102 is able to fix the plurality of functional film layers 101.

The display panel provided by embodiments of the present disclosure may be any type of display panel, for example, a flexible display panel, a single-sided display panel or a double-sided display panel, etc. If the display panel is a double-sided display panel, the nano metal film layer or the first magnetic film layer 102 and the second magnetic film layer 103 both need to be disposed in the non-display area, and specific widths thereof may be set as necessary as long as they do not affect the normal operation of the display panel and would not increase the width of the frame. When the film layer disposed on the upper surface of the stack structure is a nano metal film layer and the film layer disposed on the lower surface of the stack structure is a magnetic film layer, the width of the magnetic film layer may be set as necessary to be slightly greater than that of the nano metal film layer, so that the magnetic force for attracting them to each other is able to better fix the plurality of functional film layers.

Based on the same inventive concept, embodiments of the present disclosure provide a display device comprising the above-described display panel provided by embodiments of the present disclosure. Since the principle of the display device for solving the problem is similar to that of the above-described display panel, the implementation of the display device may refer to the implementation of the above-described display panel, which will not be described in detail for simplicity.

In summary, in the embodiments of the present disclosure, the upper surface and the lower surface of the stack structure are respectively provided with two film layers which can be attracted to each other by a magnetic force, and respective film layers of the display panel are fixed by a magnetic force, so that the optical adhesive in the existing display panel is replaced, thereby reducing the thickness of the display panel and further realizing an ultra-thin design of the display panel.

Apparently, those skilled in the art can make various modifications and variations to the present disclosure without departing from the spirit and scope thereof. In this way, if these modifications and variations to the present disclosure fall within the scope of the claims of the present invention and equivalent technologies thereof, the present disclosure also intends to encompass these modifications and variations.

1. A display panel comprising:
a stack structure comprising a plurality of functional film layers stacked successively; and
two film layers which are disposed on an upper surface and a lower surface of the stack structure, respectively and attractable to each other by a magnetic force.

2. The display panel according to claim 1, wherein the two film layers are a first magnetic film layer disposed on the upper surface of the stack structure, and a second magnetic film layer disposed on the lower surface of the stack structure, respectively.

3. The display panel according to claim 2, wherein materials of the first magnetic film layer and the second magnetic film layer are a mixture of a magnetic material and a sizing having a viscosity value smaller than a preset threshold, wherein the preset threshold is the minimum viscous value that affects the normal operation of the display panel.

4. The display panel of claim 3, wherein the magnetic material is one or a combination of any of the following materials:
nano iron chrome cobalt, nano aluminum nickel cobalt, nano samarium cobalt and nano rubidium iron boron.

5. The display panel according to claim 3, wherein a mass ratio of the magnetic material in the mixture is 0.03% to 0.17%.

6. The display panel according to claim 3, wherein the sizing is a quick-drying paint.

7. The display panel according to claim 2, wherein the upper surface of the stack structure is a display surface, and the first magnetic film layer is disposed in a non-display area of the display panel.

8. The display panel according to claim 2, wherein a thickness of the first magnetic film layer is 5 μm.

9. The display panel according to claim 2, wherein the lower surface of the stack structure is a non-display surface, and the second magnetic film layer is an entire layer.

10. The display panel according to claim 2, wherein a thickness of the second magnetic film layer is not more than 5 μm.

11. The display panel according to claim 1, wherein the display panel is a flexible display panel.

12. A display device comprising a display panel, the display panel comprising:
a stack structure comprising a plurality of functional film layers stacked successively; and
two film layers which are disposed on an upper surface and a lower surface of the stack structure, respectively and attractable to each other by a magnetic force.

13. The display panel according to claim 1, wherein the two film layers are a nano metal film layer disposed on the upper surface of the stack structure, and a second magnetic film layer disposed on the lower surface of the stack structure, respectively.

14. The display panel according to claim 13, wherein the upper surface of the stack structure is a display surface, and the nano metal film layer or the first magnetic film layer is disposed in a non-display area of the display panel.

15. The display panel according to claim 13, wherein a thickness of the nano metal film layer is 5 μm.

16. The display panel according to claim 13, wherein the lower surface of the stack structure is a non-display surface, and the second magnetic film layer is an entire layer.

17. The display panel according to claim 13, wherein a thickness of the second magnetic film layer is not more than 5 μm.

18. The display panel according to claim 2, wherein the lower surface of the stack structure is a non-display surface, and the second magnetic film layer is disposed in a non-display area of the display panel.

19. The display panel according to claim 13, wherein the lower surface of the stack structure is a non-display surface, and the second magnetic film layer is disposed in a non-display area of the display panel.

20. The display panel according to claim 2, wherein the display panel is a flexible display panel.
